(19) United States
(12) Patent Application Publication
(10) Pub. No.: US 2021/0308775 A1
(43) Pub. Date: Oct. 7, 2021

(54) Condensation2Clear

(71) Applicant: John Affleck, Chandlers Ford (GB)

(72) Inventor: John Affleck, Chandlers Ford (GB)

(21) Appl. No.: 16/840,531

(22) Filed: Apr. 6, 2020

(51) Int. Cl. B23B 49/02; E06B 7/14

(52) U.S. Cl. CPC B23B 49/02; E06B 7/14

(57) ABSTRACT

The present invention relates to a new and useful improvements for treating a glazing panel from an inside or outside location. Moreover, the present invention relates to a method of treating glazing panels used in windows through DIY repair kit which empowers any person who can drill a hole to be able to repair or re-engineer failed double glazed units by removing condensation from the failed unit.

### BACKGROUND

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to repairing/re-engineering of double glazed sealed units condensation to clear fog mist. The invention is a DiY kit which is a novel improvement template for drilling a hole through one pane of the sealed unit.

### DESCRIPTION OF THE RELATED ART

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof; to anything stated or implied therein or inferred thereupon.

Known glazing panels comprise two or more panes of glass spaced apart a short distance and the gap between them sealed peripherally either by a spacer or the frame of the window, patio door, or other opening in which it is installed.

In use, such a glazing panel may develop one or more leaks in the peripheral seal, allowing moist air and/or other contamination to enter the air space. In other cases, vent holes provided to avoid excessive pressure/vacuum build up as the glazing panel is heated or cooled may admit such moist air and/or contamination. Under certain conditions, moisture may condense out of the air within the air space and form condensation on the inner surface of at least one of the panes. This reduces visibility through the panel. Even if the glazing panel warms up and the moisture evaporates, it may leave a deposit of minerals, for example, on the pane, again reducing visibility. Moreover, it is also possible for other forms of contamination, such as particulate matter, to be drawn into the air space as the panel cools and a partial vacuum is created within it.

A method of removing and/or preventing condensation and contaminant buildup in glazing panels is described in Canadian patent No. 1,332,541, to which the reader is directed to for reference. The method involves forming at least one hole in the external pane, removing condensation and/or contamination from the air space, and then attaching a filter means in the form of a patch to close the hole. The filter contains interstices sized to allow moisture to be expelled from the panel as the window heats, but restrict ingress of water droplets as air is drawn back into the panel as it cools. This method is not entirely satisfactory, however, but has certain limitations and disadvantages, at least for some applications.

The present invention seeks to eliminate, or at least mitigate, the limitations and disadvantages of such known method, or at least provide an alternative. None of the prior art methods have been found to be completely suitable to meet these needs and are cumbersome. The present invention provides such a method and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, and abstract as a whole.

In order to solve the above problems, the method and system of this invention focuses to a DiY ‘Do it yourself’ kit that enables a layman to get damp/condensation out of a failed double glazed sealed unit. This repair could only be previously carried out by a person trained in drilling glass. The invention allows the repair to be carried out by any untrained person.

Another embodiment of the present invention is template through which it is possible for a layman to drill the glass. The unique template, keeps a drill from slipping across the surface of the glass, whilst drilling a hole through one pane of a double glazed sealed unit.

Another object is to provide a novel constructions for a template that can be made of any or a variety of material that can be secured to a double glazed glass sealed unit for the purpose of keeping a drill in the same place whilst drilling a hole through the glass, to remove moisture from a failed double glazed sealed unit.

It is another object of this invention to provide a template tool invention can be any shape made of any material that holds a drill in place for the purpose of drilling a hole between 1 mm-10 mm diameter in a glass double glazed sealed unit.

Briefly, it is a principal object of the invention to provide a method of treating a glazing panel by drilling a hole in the exterior or interior of the glass via a generally aligned hole in the template.

One feature of the invention is that the template is being placed on one side of a double glazed glass sealed unit for the purpose of holding a drill in place to drill a hole through the glass, preventing the drill from slipping across the surface of the glass and scarring the glass.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 is a full view of the invention using the drill.

FIG. 200 shows drilling within the template.

FIG. 300 shows after and before result.

FIG. 400 shows template top view.

FIG. 500 shows template bottom view.

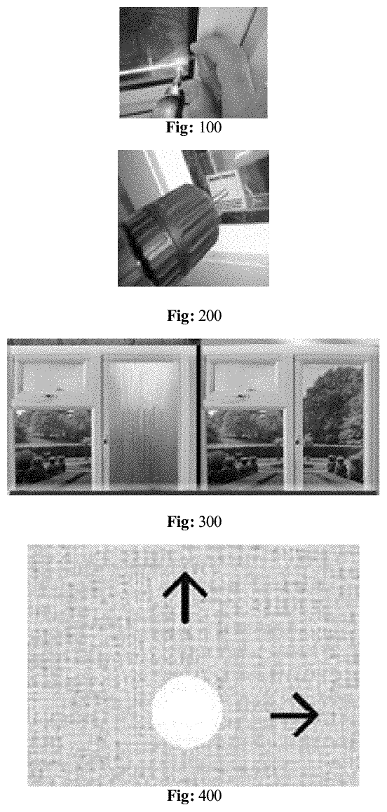

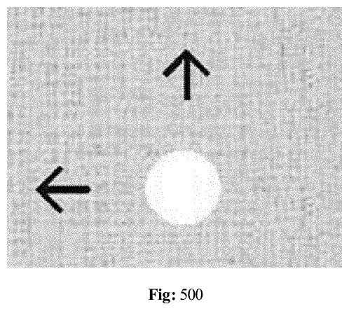

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

Unless otherwise defined, all terms (including technical and scientific terms) used herein have the same meaning as commonly understood by one having an ordinary skill in the art to which the invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques are disclosed. Each of these has individual benefit and each can also be used in conjunction with one or more, or in some cases all, of the other disclosed techniques. Accordingly, for the sake of clarity, this description will refrain from repeating possible combination in an unnecessary fashion. Nevertheless, the specifications and claim/s should be read with the understanding that such combinations are entirely within the scope of the invention and the claim/s.

The method of the present invention is that it relates to a DIY repair kit which empowers any person to drill a hole to be able to repair or re-engineer failed double glazed units by removing condensation from the failed unit. The invention is a template made of any material that can be secured to a double glazed glass sealed unit for the purpose of keeping a drill in the same place whilst drilling a hole through the glass, for the purpose of removing moisture from a failed double glazed sealed unit.

In some embodiments, the invention relates to following methods of usage;

### Method Standard Glass:

1. Using invention templates drill two tiny holes in opposite corners of the unit with specialist drills.
2. Dry out the unit with dissolving pellets.
3. Plug both holes with tiny plugs once condensation clears. (Our plug has a 0.5 mm hole so the unit will never open again under pressure).

The present invention allows an easy and inexpensive way to vent multi-glazing panels with at least one aperture and filter to suit various climatic conditions.

The invention can be any shape made of any material that holds a drill in place for the purpose of drilling a hole between 1 mm-10 mm diameter in a glass double glazed sealed unit. The invention works by being placed on one side of a double glazed glass sealed unit for the purpose of holding a drill in place to drill a hole through the glass, preventing the drill from slipping across the surface of the glass and scarring the glass.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1) The embodiments of the invention is a DIY repair kit to drill a hole to be able to repair or re-engineer failed double glazed units by removing condensation from the failed unit.

2) Template made of any material that can be secured to a double glazed glass sealed unit for the purpose of keeping a drill in the same place whilst drilling a hole through the glass, for the purpose of removing moisture from a failed double glazed sealed unit.

3) The invented template can be of any shape or material that holds a drill in place for the purpose of drilling a hole between 1 mm-10 mm diameter in a glass double glazed sealed unit.
